(19) United States
(12) Patent Application Publication
(10) Pub. No.: US 2021/0187973 A1
(43) Pub. Date: Jun. 24, 2021

(54) INKJET RECORDING APPARATUS CAPABLE OF EASY ACCESS TO A CONVEYING UNIT OF A RECORDING MEDIUM

(71) Applicant: KYOCERA Document Solutions Inc., Osaka (JP)

(72) Inventor: Daisuke ETO, Osaka (JP)

(73) Assignee: KYOCERA Document Solutions Inc., Osaka (JP)

(21) Appl. No.: 17/132,804

(22) Filed: Dec. 23, 2020

(30) Foreign Application Priority Data
Dec. 23, 2019 (JP) 2019-231816

(51) Int. Cl. B41J 11/00; B41J 29/38; B41J 2/01

(52) U.S. Cl. CPC B41J 11/0045; B41J 2/01; B41J 29/38

(57) ABSTRACT

Provided is an inkjet recording apparatus in which it is possible to easily access a conveying unit of a recording medium in the vicinity of a recording unit having a recording head. A maintenance unit is arranged so as to be movable in a horizontal direction above the conveying unit. A conveying direction drive unit moves the maintenance unit along a conveying direction of the recording medium below the recording unit that is been moved upward. In addition, the frame unit has two wall portions arranged at each of both end portions of the recording unit and the maintenance unit in a width direction orthogonal to the conveying direction of the recording medium and that support the recording unit and the maintenance unit. At least one of the two wall portions has a cutout portion in a lower side.

### INCORPORATION BY REFERENCE

This application is based on and claims the benefit of priority from Japanese Patent Application No. 2019-231816 filed on Dec. 23, 2019, the contents of which are hereby incorporated by reference.

### BACKGROUND

The present disclosure relates to an inkjet recording apparatus.

In an inkjet recording apparatus, a recording head that ejects ink onto a recording medium such as paper or the like may be moved according to various purposes. For example, in a case of performing maintenance on the recording head, the recording head may be moved upward to perform capping or cleaning on the ink ejection surface of the recording head.

For example, a typical inkjet recording apparatus has a line head moving mechanism for moving a line head, which is a recording head, in the vertical direction. This line head moving mechanism is provided with a rack and pinion mechanism on each of the front plate and the rear plate. The front plate and the rear plate are attached to the front and rear of a raising/lowering unit having a line head group. The front and rear of the raising/lowering unit are both end portions in the paper width direction orthogonal to the paper conveying direction. A motor rotates gears that engage with racks provided on the front plate and the rear plate, respectively. As a result, the line head group moves up and down together with the raising/lowering unit.

### SUMMARY

In order to solve the problem described above, the inkjet recording apparatus according to the present disclosure includes a recording unit, a conveying unit, a maintenance unit, a frame unit, a vertical drive unit, and a conveying direction drive unit. The recording unit records an image by ejecting ink onto a recording medium. The conveying unit is arranged below the recording unit and conveys the recording medium. The maintenance unit is arranged so as to be movable in a horizontal direction above the conveying unit and performs maintenance on an ink ejection surface of the recording unit. The frame unit movably supports the recording unit and the maintenance unit. The vertical drive unit moves the recording unit in a vertical direction. The conveying direction drive unit moves the maintenance unit along a conveying direction of the recording medium below the recording unit that is been moved upward. The frame unit has two wall portions arranged at each of both end portions of the recording unit and the maintenance unit in a width direction orthogonal to the conveying direction of the recording medium and that support the recording unit and the maintenance unit. At least one of the two wall portions has a cutout portion in a lower side.

### BRIEF DESCRIPTION OF THE DRAWINGS

FIG. 1 is a schematic cross-sectional front view of the inkjet recording apparatus of an embodiment according to the present disclosure.

FIG. 2 is a schematic plan view of the periphery of a recording unit of the inkjet recording apparatus in FIG. 1.

FIG. 3 is an external perspective view of the periphery of the recording unit of the inkjet recording apparatus in FIG. 1.

FIG. 4 is a schematic cross-sectional front view illustrating the periphery of the recording unit of the inkjet recording apparatus in FIG. 1.

FIG. 5 is a perspective view of the recording unit in FIG. 3 as viewed from the front.

FIG. 6 is a perspective view of a frame unit in FIG. 3 as viewed from the front.

FIG. 7 is a perspective view of the frame unit in FIG. 3 as viewed from the rear.

FIG. 8 is a perspective view of the recording unit in FIG. 3 as viewed from above.

FIG. 9 is a perspective view of the recording unit in FIG. 3 as viewed from below.

FIG. 10 is a schematic plan view of a vertical drive unit of the recording unit in FIG. 4.

FIG. 11 is a side view of the recording unit in FIG. 3.

FIG. 12 is a side view of the recording unit in FIG. 3, and illustrates a state in which the recording unit is raised.

FIG. 13 is a partial perspective view of the periphery of the recording unit in FIG. 3, and illustrates a state in which the recording unit is raised.

### DETAILED DESCRIPTION

Hereinafter, embodiments according to the present disclosure will be described with reference to the drawings. Note that the technique according to the present disclosure is not limited to the following contents.

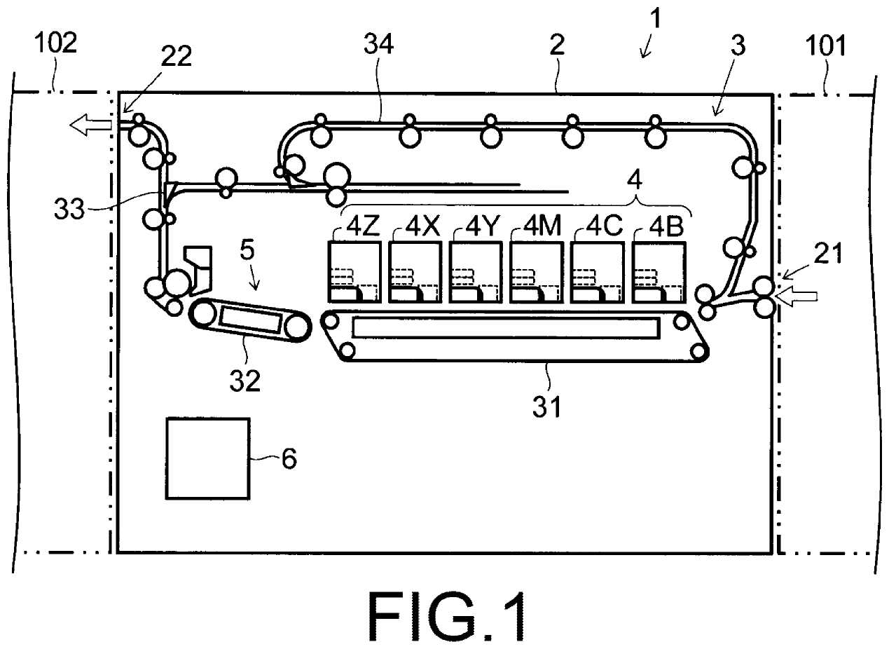

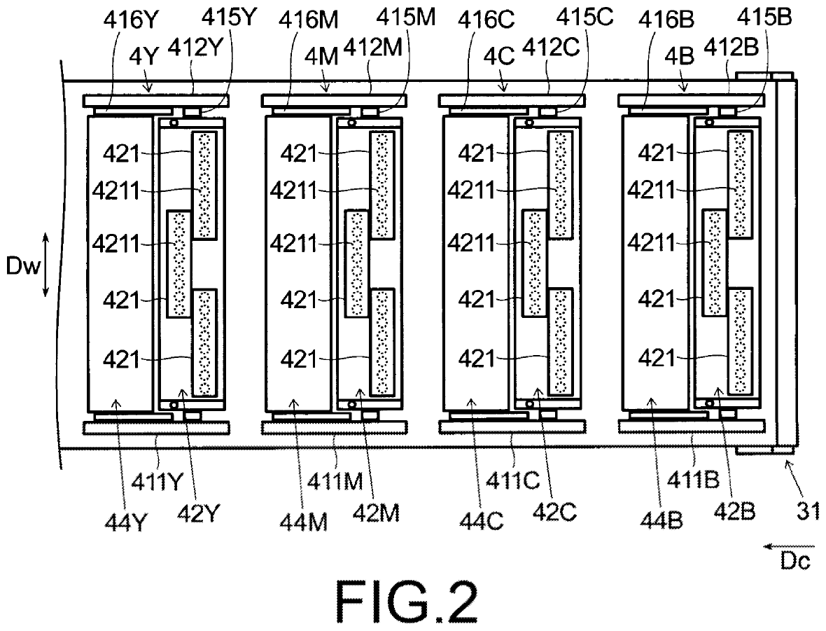

FIG. 1 is a schematic cross-sectional front view of the inkjet recording apparatus 1 of an embodiment. FIG. 2 is a schematic plan view of the periphery of a recording unit 4 of the inkjet recording apparatus 1 in FIG. 1. The inkjet recording apparatus 1 is, for example, an inkjet recording type printer. The inkjet recording apparatus 1 is connected between, for example, a paper supply device 101 and a paper post-processing device 102.

The paper supply device 101 accommodates a plurality of sheets of paper (recording medium), separates the sheets of paper one by one at the time of recording in the inkjet recording apparatus 1, and feeds the paper out to the inkjet recording apparatus 1. The inkjet recording apparatus 1 conveys the paper fed out by the paper supply device 101 from the paper inlet 21. Note that the inkjet recording apparatus 1 itself may be provided with a paper supply unit.

The paper post-processing device 102 receives the paper on which an image is recorded by the inkjet recording apparatus 1. The paper post-processing device 102 performs post processing on the paper as necessary and discharges the paper. The inkjet recording apparatus 1 discharges the paper on which an image is recorded from the paper-discharge port 22 to the paper post-processing device 102. Note that the inkjet recording apparatus 1 itself may be provided with a paper-discharge tray or the like.

As illustrated in FIGS. 1 and 2, the inkjet recording apparatus 1 includes a device main body 2, a paper conveying unit 3, a recording unit 4, a drying unit 5, and a control unit 6.

The paper conveying unit 3 conveys the paper received from the paper supply device 101 via the paper input port 21 to the recording unit 4 and the drying unit 5. Furthermore, the paper conveying unit 3 conveys the paper after recording and drying from the paper-discharge port 22. In a case where double-sided recording is performed, the paper conveying unit 3 distributes the recorded and dried paper on a first surface to a reverse conveying unit 34 by a branching unit 33. Furthermore, the paper conveying unit 3 switches the conveying direction and inverts the front and back sides. The paper conveying unit 3 conveys the paper that has been inverted from front to back to the recording unit 4 and the drying unit 5 again.

The paper conveying unit 3 has a first belt conveying unit 31 and a second belt conveying unit 32. The first belt conveying unit 31 and the second belt conveying unit 32 attract and hold the paper on the upper surface of a continuous belt and convey the paper. The first belt conveying unit 31 conveys paper that is arranged below the recording unit 42, which will be described later. The second belt conveying unit 32 conveys paper that is arranged in the drying unit 5.

The recording unit 4 is arranged on the downstream side in the paper conveying direction of the paper input port 21 and on the upstream side in the paper conveying direction of the drying unit 5. The recording unit 4 faces the paper that is attracted to and held on the upper surface of the belt of the first belt conveying unit 31 and conveyed. The recording unit 4 is arranged above the first belt conveying unit 31 at a specified interval.

The recording unit 4 includes recording units 4B, 4C, 4M, 4Y, 4X, and 4Z provided corresponding to each of the four colors of black, cyan, magenta, and yellow, and two other colors. The six-color recording units 4B, 4C, 4M, 4Y, 4X, and 4Z are arranged side-by-side along the paper conveying direction. The recording units 4B, 4C, 4M, 4Y, 4X, and 4Z sequentially eject six colors of ink onto the paper and record a full-color image or a monochrome image on the paper. This paper is conveyed by the first belt conveying unit 31. The detailed configuration of the recording unit 4 will be described later.

The drying unit 5 is arranged on the downstream side in the paper conveying direction of the recording unit 4, and a second belt conveying unit 32 is provided. The paper on which an ink image is recorded by the recording unit 4 is attracted to and held on the upper surface of the belt of the second belt conveying unit 32 in the drying unit 5 and conveyed. During this time the ink is dried.

The control unit 6 includes a CPU, a storage unit, other electronic circuits, and electronic components. The CPU controls the operation of each component provided in the inkjet recording apparatus 1 based on a control program and data stored in the storage unit. As a result, the CPU performs processing related to the functions of the inkjet recording apparatus 1. Each of the paper conveying unit 3, the recording unit 4, and the drying unit 5 receives commands individually from the control unit 6 and records on paper in conjunction with each other. The storage unit is configured, for example, by a combination of a non-volatile storage device and a volatile storage device. The non-volatile storage device is a program ROM (Read Only Memory), data ROM, or the like. The volatile storage device is a RAM (Random Access Memory) or the like.

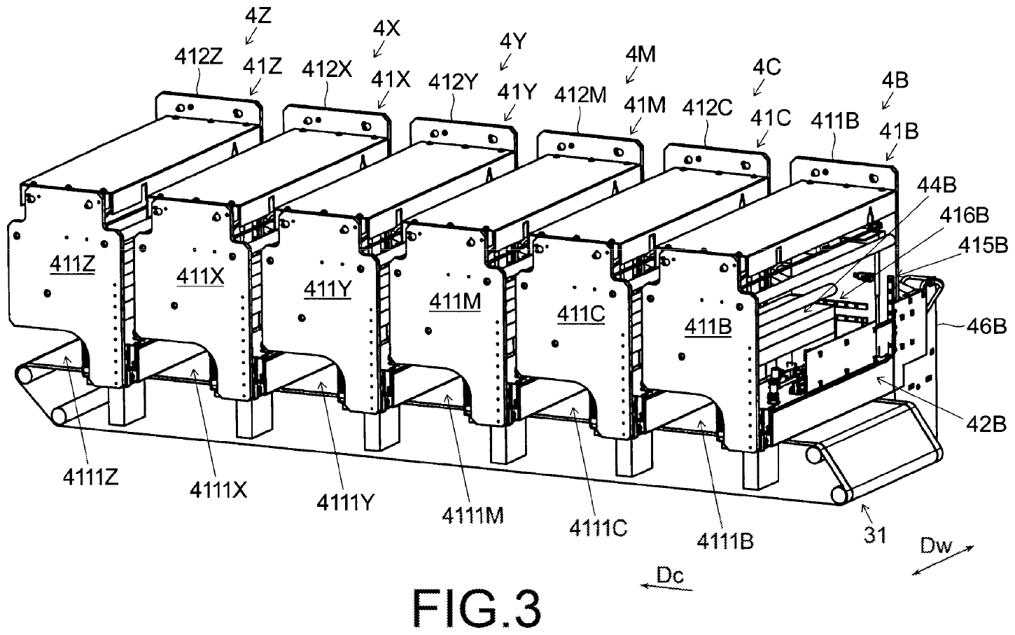

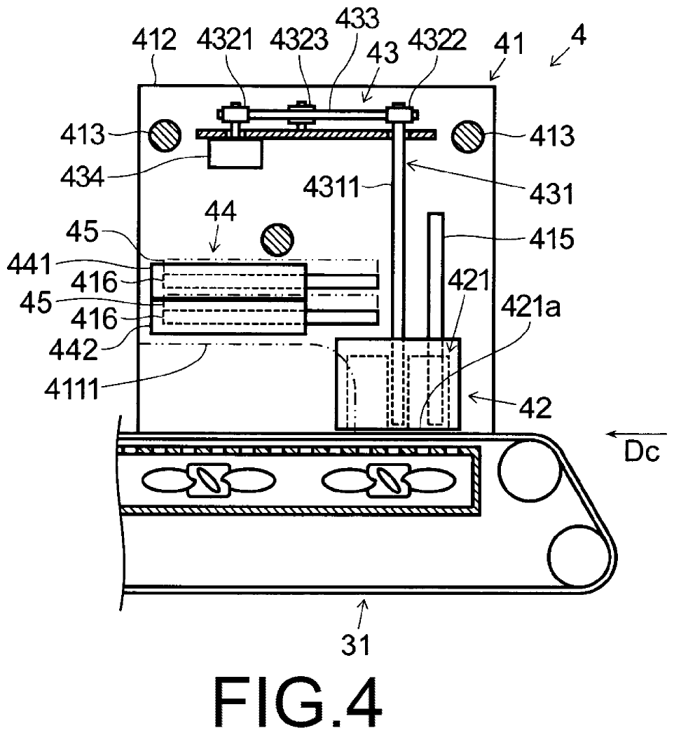

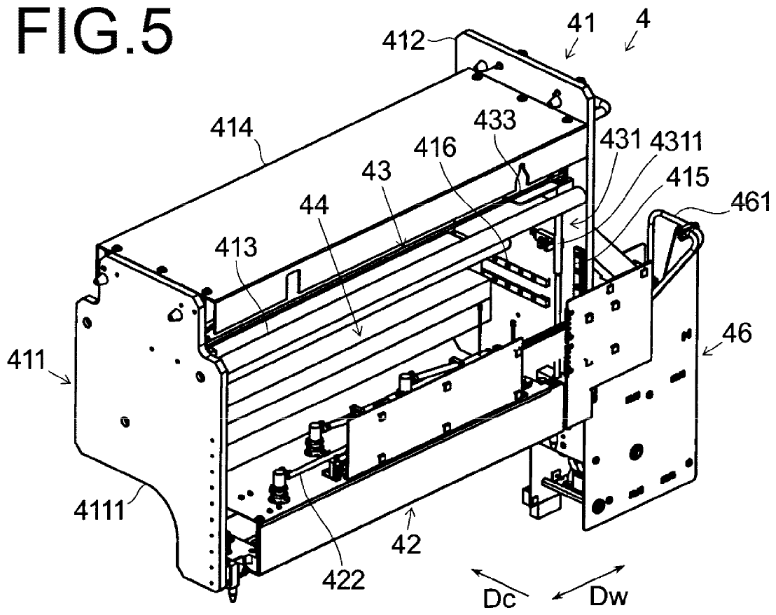

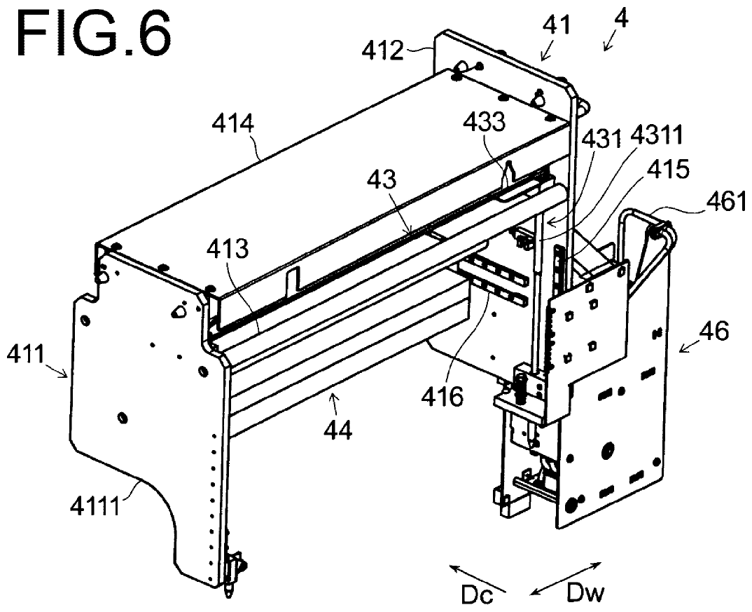

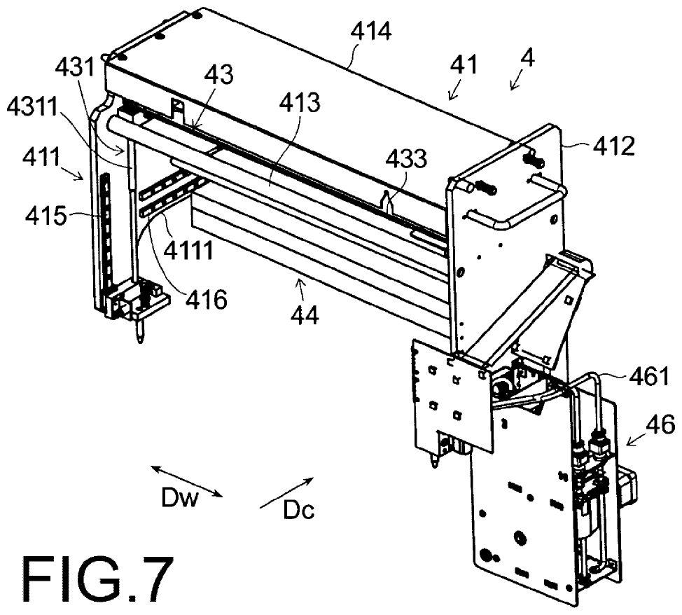

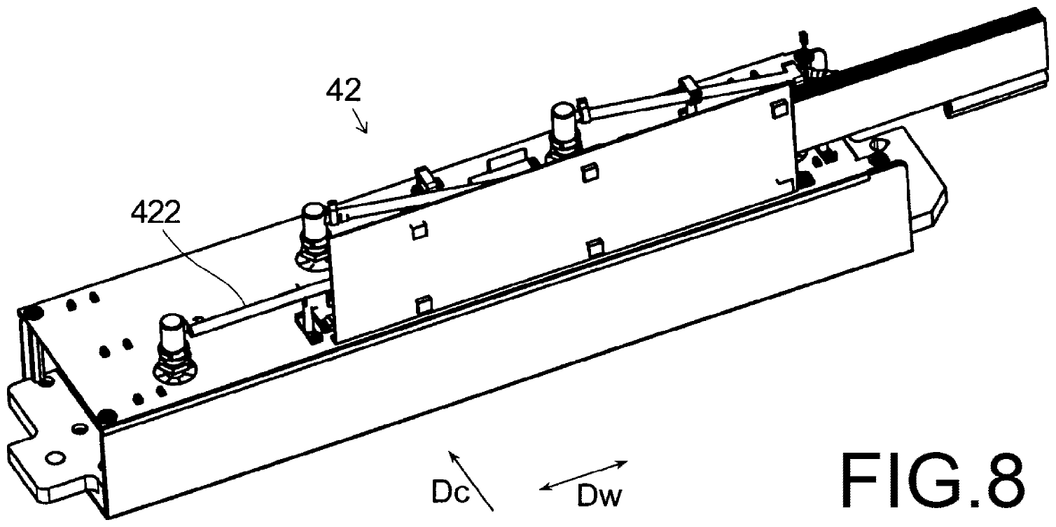

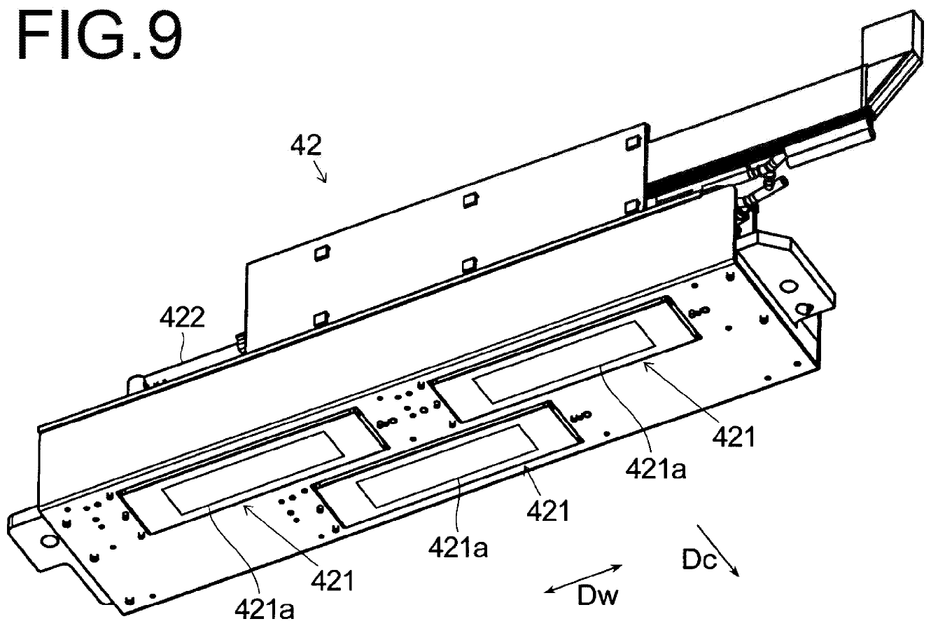

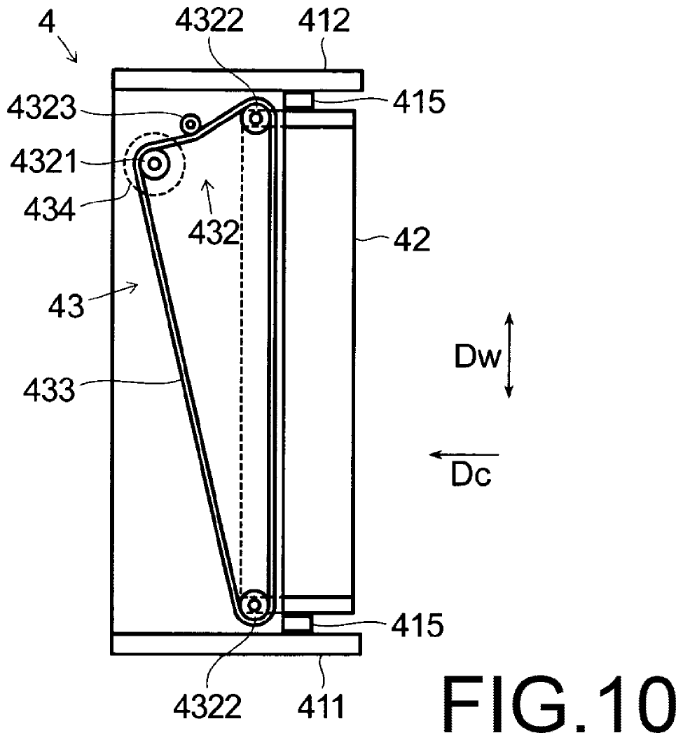

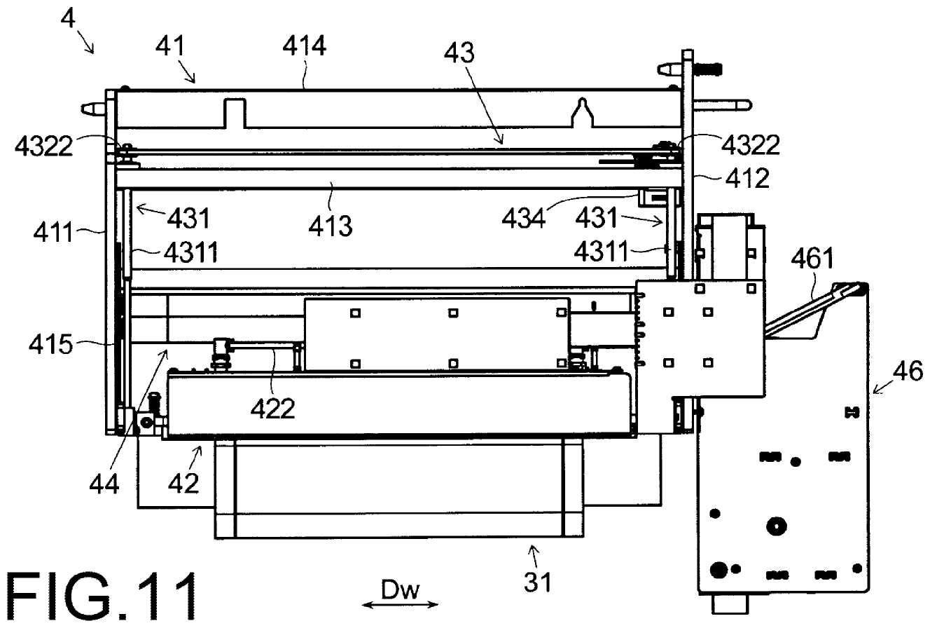

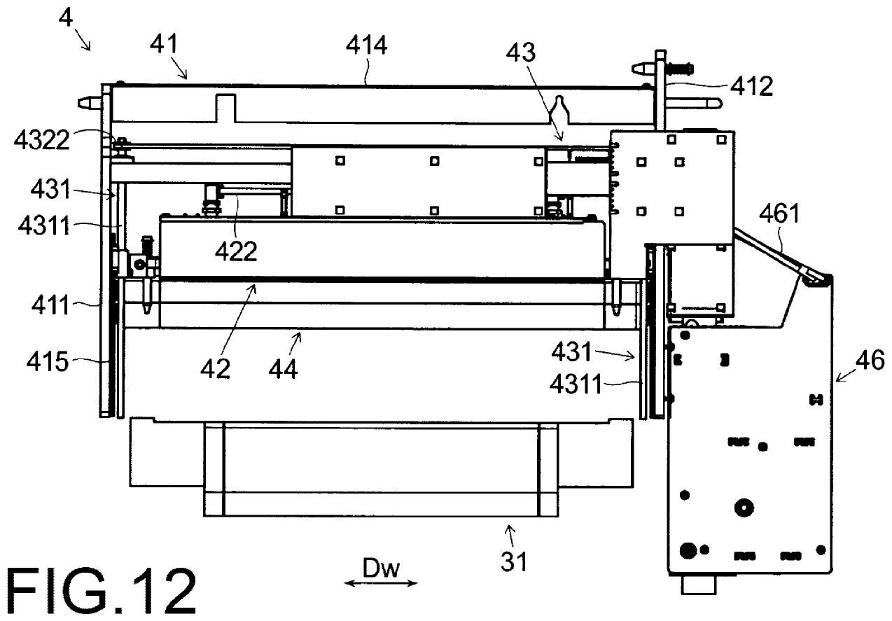

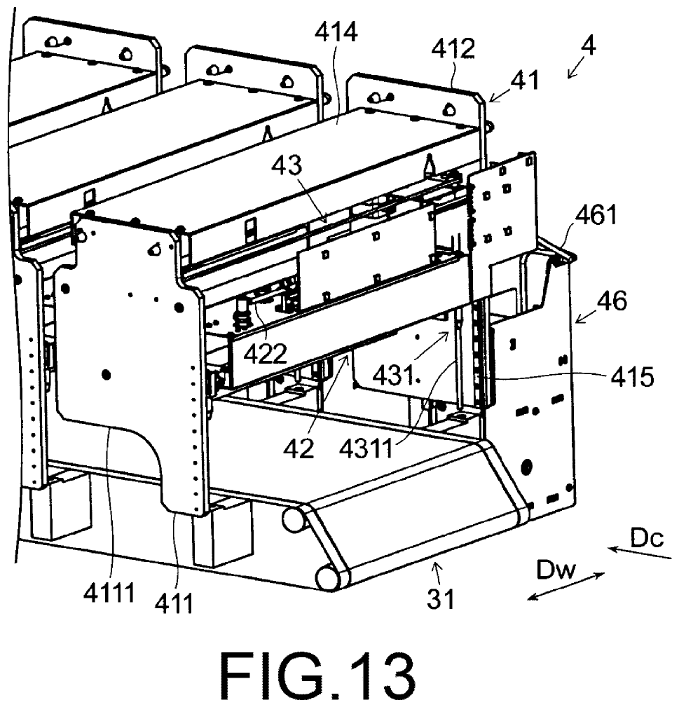

Next, the configuration of the recording unit 4 of the inkjet recording apparatus 1 will be described with reference to FIGS. 3 to 13 in addition to FIGS. 1 and 2. FIG. 3 is an external perspective view of the periphery of the recording unit 4 of the inkjet recording apparatus 1 in FIG. 1. FIG. 4 is a schematic plan view of the periphery of the recording unit 4 of the inkjet recording apparatus 1 in FIG. 1. FIG. 5 is a perspective view of the recording unit 4 in FIG. 3 as viewed from the front. FIG. 6 is a perspective view of a frame unit 41 in FIG. 3 as viewed from the front. FIG. 7 is a perspective view of the frame unit 41 in FIG. 3 as viewed from the rear. FIG. 8 is a perspective view of the recording unit 42 in FIG. 3 as viewed from above. FIG. 9 is a perspective view of the recording unit 42 in FIG. 3 as viewed from below. FIG. 10 is a schematic plan view of a vertical drive unit 43 of the recording unit 4 in FIG. 4. FIG. 11 is a side view of the recording unit 4 in FIG. 3. FIG. 12 is a side view of the recording unit 4 in FIG. 3, and illustrates a state in which the recording unit 42 is raised. FIG. 13 is a partial perspective view of the periphery of the recording unit 4 in FIG. 3, and illustrates a state in which the recording unit 42 is raised.

Note that in FIGS. 2, 3, 4, and 5, the right side in the drawing is the upstream side in the paper conveying direction Dc, and the left side is the downstream side in the paper conveying direction Dc. Moreover, the six-color recording units 4B, 4C, 4M, 4Y, 4X, and 4Z each have the same shape, size, and configuration. Therefore, in the following description, the description of the identification code representing each color may be omitted.

As illustrated in FIGS. 2, 3, 4, and 5, the recording unit 4 includes a frame unit 41, a recording unit 42, a vertical drive unit 43, a maintenance unit 44, and a conveying direction drive unit 45.

As illustrated in FIGS. 4 and 5, the frame unit 41 is a housing that is arranged around the recording unit 42 and the maintenance unit 44 and supports the recording unit 42 and the maintenance unit 44. As illustrated in FIGS. 5, 6 and 7, the frame unit 41 includes a front wall portion 411, a back wall portion 412, a connecting member 413, an upper cover 414, a vertical guide member 415, and a conveying direction guide member 416.

The front wall portion 411 and the back wall portion 412 are arranged so as to face each other in the paper width direction Dw orthogonal to the paper conveying direction Dc. The front wall portion 411 and the back wall portion 412 have a plate shape extending in the paper conveying direction Dc and in the vertical direction. The recording unit 42 and the maintenance unit 44 are located between the front wall portion 411 and the back wall portion 412 in the paper width direction Dw, and are supported by the respective wall portions.

A plurality of connecting members 413 are arranged between the front wall portion 411 and the back wall portion 412, and the front wall portion 411 and the back wall portion 412 are connected so as to be separated by a specified distance in the paper width direction Dw. The connecting member 413 has a rod shape extending in the paper width direction Dw.

The upper cover 414 is arranged so as to span between the front wall portion 411 and the back wall portion 412 at the upper end portion of the frame portion 41. The upper cover 414 has a plate shape extending in the paper width direction Dw and in the horizontal direction.

As illustrated in FIGS. 6 and 7, a vertical guide member 415 and a conveying direction guide member 416 are provided on the inner surface in the paper width direction Dw of both the front wall portion 411 and the back wall portion 412, respectively. A vertical guide member 415 is arranged in the upstream portion in the paper conveying direction Dc on the front wall portion 411 and the back wall portion 412, respectively. A conveying direction guide member 416 is arranged below the front wall portion 411 and the back wall portion 412, respectively.

A vertical guide member 415 is arranged at each of both end portions of the recording unit 42 in the paper width direction Dw and extend in the vertical direction. The lower end of the vertical guide member 415 extends to the vicinity of the first belt conveying unit 31. The frame portion 41 movably supports the recording unit 42 in the vertical direction via the vertical guide member 415.

A conveying direction guide member 416 is arranged at both end portions in the paper width direction Dw of the maintenance unit 44 and extends in the paper conveying direction Dc. The frame unit 41 movably supports the maintenance unit 44 in the paper conveying direction Dc via the conveying direction guide members 416.

As illustrated in FIGS. 2, 4 and 5, the recording unit 42 is arranged in the upstream portion in the paper conveying direction Dc of the frame unit 41. The recording unit 42 is individually supported by the front wall portion 411 and the back wall portion 412 at each of both end portions in the paper width direction Dw. The recording unit 42 is arranged above the first belt conveying unit 31 so as to be movable in the vertical direction.

As illustrated in FIGS. 2 and 4, the recording unit 42 faces in the vertical direction the paper that is attracted to and held on the upper surface of the belt of the first belt conveying unit 31 and conveyed. The recording unit 42 is arranged above the first belt conveying unit 31 at a specified interval. As illustrated in FIGS. 8 and 9, the recording unit 42 is configured by a rectangular parallelepiped shape extending in the paper width direction Dw. The recording unit 42 has a line-type inkjet recording head 421. A plurality (for example, three) of recording heads 421 are arranged in a staggered pattern along the paper width direction Dw.

As illustrated in FIG. 9, the recording head 421 has an ink ejection surface 421a on the bottom surface thereof. Furthermore, the recording head 421 includes a plurality of ink ejection nozzles 4211 (see FIG. 2) that open on the ink ejection surface 421a. The plurality of ink ejection nozzles 4211 are arranged side-by-side along the paper width direction Dw. The plurality of ink ejection nozzles 4211 are able to eject ink over the entire recording area of the paper. As a result, the recording head 421 ejects ink onto the paper and records an image.

Note that as illustrated in FIG. 5, an ink supply unit 46 is provided behind the back wall portion 412. The ink supply unit 46 has a sub tank for storing ink. The ink supply unit 46 is configured by a tube or the like, and supplies ink to the recording head 421 via connected ink supply paths 461, 422.

As illustrated in FIGS. 4, 10 and 11, the vertical drive unit 43 is provided in the frame unit 41. The vertical drive unit 43 moves the recording unit 42 in the vertical direction along the vertical guide member 415. The vertical drive unit 43 includes a ball screw unit 431, a pulley 432, a timing belt 433, and a motor 434.

Ball screw units 431 are arranged at both end potions of the recording unit 42 in the paper width direction Dw, respectively. The ball screw unit 431 includes a screw shaft 4311 and a nut portion. The screw shaft 4311 extends in the vertical direction. The nut portion includes a large number of balls inside and is attached to the screw shaft 4311. The nut portion is connected to the end portion of the recording unit 42 in the paper width direction Dw. When the screw shaft 4311 rotates, the recording unit 42 connected to the nut portion moves in the vertical direction along the rotation axis of the screw shaft 4311. In other words, the recording unit 42 is connected to the ball screw unit 431 so as to be able to move in the vertical direction.

The pulley 432 includes a drive pulley 4321, a driven pulley 4322, and a tension pulley 4323. The drive pulley 4321 is attached to the shaft portion of the motor 434 so as to be aligned with the rotation axis, and is rotated by the motor 434. A driven pulley 4322 is attached to the upper end potion of each of the two screw shafts 4311 so as to be aligned with the rotation axis. The tension pulley 4323 comes into contact with the outer peripheral portion of a timing belt 433.

The timing belt 433 is wound around the drive pulley 4321 and the two driven pulleys 4322. Note that the tension pulley 4323 may be brought into contact with and press against the outer peripheral portion of the timing belt 433. As a result, the tension of the timing belt 433 may be adjusted.

The motor 434 rotates the timing belt 433 via the drive pulley 4321. When the timing belt 433 rotates, the two screw shafts 4311 rotate at the same time via each of the two driven pulleys 4322. As a result, the recording unit 42 moves in the vertical direction while maintaining the horizontal position.

FIG. 11 illustrates a state in which the recording unit 42 is arranged at the ink ejection position at the lower end. On the other hand, FIGS. 12 and 13 illustrate a state in which the recording unit 42 is raised by the vertical drive unit 43, for example, for maintenance. In this way, the vertical drive unit 43 moves the recording unit 42 in the vertical direction.

As illustrated in FIGS. 2, 4, 5, and 6, the maintenance unit 44 is arranged below the frame unit 41. The maintenance unit 44 is individually supported by the front wall portion 411 and the back wall portion 412 at each of both end portions in the paper width direction Dw. The maintenance unit 44 is arranged so as to be movable in the horizontal direction above the first belt conveying unit 31.

The maintenance unit 44 performs maintenance on the ink ejection surface 421a of the recording head 421 in which the ink ejection nozzles 4211 open. During maintenance, the recording unit 42 moves upward. The maintenance unit 44 includes a cap unit 441 and a cleaning unit 442.

During maintenance, the cap unit 441 is on the upstream side in the paper conveying direction Dc, and moves horizontally below the recording unit 42 that has moved upward. The cap unit 441 is attached to the lower side of the recording head 421 and is used for capping the ink ejection surface 421a. By performing capping of the ink ejection surface 421a, it is possible to suppress drying and solidification of the ink.

During maintenance, the cleaning unit 442 is on the upstream side in the paper conveying direction Dc, and moves horizontally below the recording unit 42 that has moved upward. The cleaning unit 442 presses a wiper member into contact with the ink ejection surface 421a of the recording head 421. The cleaning unit 442 moves the wiper member in the paper width direction Dw and performs cleaning of the ink ejection surface 421a. By performing cleaning of the ink ejection surface 421a, solidified ink and other foreign substances adhering to the ink ejection surface 421a may be removed.

As illustrated in FIG. 4, the conveying direction drive unit 45 is provided in the frame unit 41. The conveying direction drive unit 45 moves the maintenance unit 44 in the paper conveying direction Dc along the conveying direction guide member 416 below the recording unit 42 that has been moved upward.

More specifically, the conveying direction drive unit 45 individually moves each of the cap unit 441 and the cleaning unit 442 along the paper conveying direction Dc below the recording unit 42 that has been moved upward. As in the case of the vertical drive unit 43, the conveying direction drive unit 45 includes a ball screw unit, a pulley, a timing belt, and a motor for individually moving the cap unit 441 or the cleaning unit 442.

The front wall portion 411 and the back wall portion 412 of the frame unit 41 are arranged at each of both end portions in the paper width direction Dw of the recording unit 42 and the maintenance unit 44. The front wall portion 411 and the back wall portion 412 support the recording unit 42 and the maintenance unit 44.

In the present embodiment, the front wall portion 411 includes a cutout portion 4111 as illustrated in FIGS. 3 and 13. Note that the cutout portion 4111 may be provided on at least one of the front wall portion 411 and the back wall portion 412. In other words, the cutout portion 4111 may be provided on the back wall portion 412, or may be provided on both the front wall portion 411 and the back wall portion 412.

The cutout portion 4111 is formed on the lower side of the back wall portion 412 or the front wall portion 411, or in other words, on the first belt conveying unit 31 side in the vertical direction. Moreover, the cutout portion 4111 is formed in the vicinity of the upper surface of the first belt conveying unit 31 along the paper conveying direction Dc. The cutout portion 4111 has a substantially rectangular shape when viewed from the front, for example.

With configuration described above, when a hand is put through the cutout portion 4111 of the front wall portion 411, the hand is able to reach the first belt conveying unit 31 in the vicinity of the recording unit 42. Therefore, it is possible to easily access the first belt conveying unit 31 in the vicinity of the recording unit 42 having the recording head 421. That is, in a case where a paper jam occurs in the vicinity of the recording unit 42, the jam can be easily treated.

FIG. 4 illustrates the state at the time of recording. In other words, the recording unit 42 is moved downward by the vertical drive unit 43. In addition, the maintenance unit 44 is moved by the conveying direction drive unit 45 to a position different from that of the recording unit 42 in the conveying direction. In this state, the lower end of the maintenance unit 44 is located above the lower end of the recording unit 42. In other words, the gap existing above the first belt conveying unit 31 located below the maintenance unit 44 is larger in the vertical direction than the gap existing above the first belt conveying unit 31 located below the recording unit 42. With this configuration, when performing the treatment of a jam in a state at the time of recording, it is possible to put a hand in the large gap under the maintenance unit 44. Therefore, it is possible to easily access the first belt conveying unit 31 in the vicinity of the recording unit 42.

As shown in FIGS. 3, 4, and 5, the cutout portion 4111 is arranged in a downstream portion in the paper conveying direction Dc of the front wall portion 411. Note that the recording unit 42 is arranged on the first belt conveying unit 31 side in an upstream portion in the paper conveying direction Dc side of the front wall portion 411. The cutout portion 4111 has a portion located below the maintenance unit 44. With this configuration, the cutout portion 4111 serves as an opening to the space provided below the maintenance unit 44 in the frame unit 41. Therefore, a hand can be easily inserted in the vicinity of the recording unit 42 to access the belt of the first belt conveying unit 31. In other words, it is possible to easily remove the jammed paper in the vicinity of the recording unit 42.

Note that the recording unit 42 may freely connected to and disconnect from each of the vertical guide member 415 and the ball screw unit 431 at both end portions in the paper width direction Dw. In other words, the recording unit 42 may be attached to or removed from the frame unit 41 and the vertical drive unit 43. With this configuration, the recording unit 42 may be removed from the frame unit 41 and the vertical drive unit 43. As a result, the first belt conveying unit 31 may be easily accessed even below the recording unit 42. In other words, even in a case where a paper jam occurs below the recording unit 42, treatment of jam may be easily performed.

Moreover, the recording unit 4 includes a recording unit 42, a maintenance unit 44, a frame unit 41, a vertical drive unit 43, and a conveying direction drive unit 45, and records a monochromatic image. The recording unit 42 ejects a single color of ink. The maintenance unit 44 performs maintenance on the recording unit 42. The frame unit 41 supports the recording unit 42 and the maintenance unit 44. The vertical drive unit 43 moves the recording unit 42 in the vertical direction. The conveying direction drive unit 45 moves the maintenance unit 44 along the paper conveying direction Dc. In the present embodiment, six recording units 4 are arranged side-by-side above the first belt conveying unit 31 along the paper conveying direction Dc corresponding to each of the six colors.

With this configuration, the frame unit 41, the recording unit 42, the vertical drive unit 43, the maintenance unit 44, and the conveying direction drive unit 45 are individually grouped for each of a plurality of colors. As a result, they configure a recording unit 4. A cutout portion 4111 is individually formed in all recording units 4. In other words, in each of the plurality of recording units 4, it is possible to easily access the first belt conveying unit 31 in the vicinity of the recording unit 42. That is, in a case where a paper jam occurs in the vicinity of the recording unit 42 of each of the plurality of recording units 4, the treatment of the jam may be performed individually.

Moreover, the frame unit 41, the recording unit 42, the vertical drive unit 43, the maintenance unit 44, and the conveying direction drive unit 45 may be unitized for each color. As a result, in a case where a problem occurs due to, for example, a paper jam or the like, the unit may be replaced. Therefore, in the inkjet recording apparatus 1, maintainability may be improved and it is possible to reduce downtime.

To summarize the above, in a typical technique, a front plate and a rear plate of the housing are provided in front of and behind a housing that supports the raising/lowering unit having a line head group. In front of and behind these are both end portions in the paper width direction. For this reason, it is not possible to easily access the conveying unit of the recording medium in the vicinity of the line head group. As a result, in a case where a recording medium is jammed in the vicinity of the line head group, it may not be possible to easily handle the jam.

In view of the above points, an object according to the present disclosure is to provide an inkjet recording apparatus in which it is possible to easily access a conveying unit of a recording medium in the vicinity of a recording unit having a recording head.

More specifically, with the configuration according to the present disclosure, when a hand is put through the cutout portion of the wall portion, the hand is able to reach the conveying unit of the recording medium in the vicinity of the recording unit. Therefore, it is possible to easily access the conveying unit of the recording medium in the vicinity of the recording unit having the recording head. In other words, in a case where a jam of a recording medium occurs in the vicinity of the recording unit, treatment of the jam may be easily performed.

Embodiments according to the present disclosure have been described above; however, the scope of the present disclosure is not limited to this, and various modifications may be made without departing from the gist of the invention.

As industrial applicability, the technique according to the present disclosure may be used in an inkjet recording apparatus.

What is claimed is:

1. An inkjet recording apparatus, comprising:
a recording unit that records an image by ejecting ink onto a recording medium;
a conveying unit that is arranged below the recording unit and conveys the recording medium;
a maintenance unit that is arranged so as to be movable in a horizontal direction above the conveying unit and performs maintenance on an ink ejection surface of the recording unit;
a frame unit that movably supports the recording unit and the maintenance unit;
a vertical drive unit that moves the recording unit in a vertical direction; and
a conveying direction drive unit that moves the maintenance unit along a conveying direction of the recording medium below the recording unit that is been moved upward; wherein
the frame unit has two wall portions arranged at each of both end portions of the recording unit and the maintenance unit in a width direction orthogonal to the conveying direction of the recording medium and that support the recording unit and the maintenance unit; and
at least one of the two wall portions has a cutout portion in a lower side.

2. The inkjet recording apparatus according to claim 1, wherein
the cutout portion has a portion located below the maintenance unit.

3. The inkjet recording apparatus according to claim 1, wherein
a gap existing above the conveying unit located below the maintenance unit when the maintenance unit is arranged at a position different from the recording unit in the conveying direction is larger in the vertical direction than a gap existing above the conveying unit located below the recording unit when the recording unit is arranged at a position in the vertical direction for recording an image.

4. The inkjet recording apparatus according to claim 3, wherein
the cutout portion has a portion located below the maintenance unit.

5. The inkjet recording apparatus according to claim 1 further comprises:
the recording unit that ejects the ink of a single color;
a maintenance unit that performs maintenance of the recording unit;
the frame unit that supports the recording unit and the maintenance unit; and
the vertical drive unit that moves the recording unit in the vertical direction, and the conveying direction drive unit that moves the maintenance unit along the conveying direction; wherein
a plurality of the recording units, which each recording unit records an image having a single color, are arranged side-by-side corresponding to each of a plurality of colors above the conveying unit along the conveying direction.

6. The inkjet recording apparatus according to claim 1, wherein
the recording unit is removable from the frame unit and the vertical drive unit.
